(19) United States
(12) Patent Application Publication
(10) Pub. No.: US 2023/0162562 A1
(43) Pub. Date: May 25, 2023

(54) TIPPING TO TICKET AT ELECTRONIC GAMING MACHINE (EGM) USING SERVICE WINDOW OR A MOBILE DEVICE

(71) Applicant: IGT, Las Vegas, NV (US)

(72) Inventors: Kevin Higgins, Reno, NV (US); Jeffery Shepherd, Reno, NV (US); Erik Petersen, Reno, NV (US)

(21) Appl. No.: 17/532,742

(22) Filed: Nov. 22, 2021

(51) Int. Cl. G07F 17/32; G07F 17/42

(52) U.S. Cl. CPC G07F 17/3239; G07F 17/3241; G07F 17/3251; G07F 17/42

(57) ABSTRACT

Embodiments of the present disclosure relates to a gaming system including a printer, a processor coupled with the printer, and a memory coupled with and readable by the processor. The memory can store therein a set of instructions which, when executed by the processor, causes the processor to maintain an electronic record storing a value. The value stored in the record can indicate a balance of a credit meter for a player of the gaming system. The instructions can further cause the processor to receive a request to transfer an amount from the credit meter to a physical token, validate the request to transfer the amount from the credit meter to the physical token, and in response to validating the request, update the electronic record to decrement the balance of the credit meter by the amount and generate, through the printer, the physical token with an indication of the amount.

### BACKGROUND

The present disclosure is generally directed to use of physical tokens to transfer a value between individuals and, in particular, toward generating and tracking physical tokens within a gaming venue.

In a typical casino, players often tip staff for various actions. For example, a player may tip a member of the wait staff for getting them drinks or providing food while they continue to gamble. Another typical situation when players tip casino staff is when a player hits a jackpot. Casino staff are dispatched to the gaming system, which is typically stuck in a “hand-pay” condition. The staff member then performs any jackpot verification activities, goes back to the casino cage to process the jackpot, and returns to the gaming system to provide the player their tax form and pay the player with cash or a check to pay them their winnings. After a player has been paid, they may often choose to tip the casino staff members who helped pay them out their jackpot using some portion of their winnings. For example, if a player won a $5000 jackpot, they may tip the staff member who paid them the jackpot an additional $100.

As casinos and other gaming venues move into a cashless world, the venue's systems may support keying off jackpots to the player's wagering account or back to the gaming system's credit meter. This results in a lack of physical cash being distributed to the player, even though a staff member may be involved during the jackpot process to collect the player's information in order to fill in the required jackpot tax forms. As a result, it becomes difficult for a player to tip staff members, and as a result, staff members may no longer offer players the level of service they typically expect. This may also create a serious issue with adoption of cashless features in casinos and other gaming venues as staff will have a disincentive, i.e., lower earnings due to lower tips, to promote cashless adoption, which presents a product challenge for the adoption of electronic cashless solutions. Hence, there is a need in the art for improved methods and systems for electronically transferring value between individuals in a cashless gaming venue solution.

### BRIEF SUMMARY

In certain embodiments, the present disclosure relates to an electronic gaming system comprising a printer, a processor coupled with the printer, and a memory coupled with and readable by the processor. The memory can store therein a set of instructions which, when executed by the processor, causes the processor to maintain an electronic record storing a value. The value stored in the record can indicate a balance of a credit meter for a player of the gaming system. The instructions can further cause the processor to receive a request to transfer an amount from the credit meter to a physical token and validate the request to transfer the amount from the credit meter to the physical token. For example, validating the request to transfer the amount from the credit meter to the physical token can comprise determining the balance of the credit meter indicated by the electronic record exceeds the amount to be transferred to the physical token. In response to validating the request to transfer the amount from the credit meter to the physical token, the instructions can cause the processor to update the electronic record to decrement the balance of the credit meter by the amount and generate, through the printer, the physical token with an indication of the amount.

For example, the gaming system can further comprise a display device coupled with the processor and the instructions can further cause the processor to present a user interface on the display device. In such cases, the request to transfer the amount from the credit meter to the physical token can be received through the user interface and validating the request to transfer the amount from the credit meter to the physical token can comprise requesting, via the user interface, identification information from the player of the gaming system and confirmation of the request from the player of the gaming system.

In another example, the gaming system can additionally, or alternatively, comprise a communications interface coupled with the processor. In such cases, the request to transfer the amount from the credit meter to the physical token can be received from a mobile device of the player of the gaming system via the communications interface system and validating the request to transfer the amount from the credit meter to the physical token can comprise requesting, through the communications interface, from the mobile device of the player, identification information from the player of the gaming system and confirmation of the request from the player of the gaming system.

In some cases, the instructions can further cause the processor to disable transfers from the credit meter to the physical token under a set of predefined conditions.

According to another embodiment, a ticketing system of a gaming venue can comprise a communications interface, a processor coupled with the communications interface, and a memory coupled with and readable by the processor. The memory can store therein a set of instructions which, when executed by the processor, causes the processor to maintain an electronic record for a player of the gaming venue. The electronic record can comprise a field storing a value indicating an account balance amount for the player. The instructions can further cause the processor to receive, from a gaming system of the gaming venue, through the communications interface, an electronic message indicating a request to transfer an amount from the account balance for the player to a physical token and validate the request to transfer the amount from the account balance for the player to the physical token.

Validating the request to transfer the amount from the account balance for the player to the physical token can comprise sending, through the communications interface, to a mobile device of the player, an electronic message indicating the transfer and requesting an approval of the transfer. In such cases, validating the request to transfer the amount from the account balance for the player to the physical token can be based on receiving, through the communications interface, from the mobile device of the player, an electronic message approving the transfer. The electronic message sent to the mobile device of the player can, in some cases, further request identifying information for the player, and validating the request to transfer the amount from the account balance for the player to the physical token can comprise receiving an electronic message including the requested identifying information from the mobile device of the player.

In response to validating the request to transfer the amount from the account balance for the player to the physical token, the instructions can further cause the processor to update the electronic record to decrement the account balance amount by the amount and send, to the gaming system, through the communication interface, an electronic message comprising an instruction to initiate printing of the physical token with an indication of the amount by the gaming system.

Additionally, or alternatively, the instructions can cause the processor to maintain an electronic record of the request and track activity related to the physical token. Based on tracking the activity related to the physical token, the instructions can further cause the processor to identify an activity predefined as a suspicious activity. In some cases, the instructions can further cause the processor to initiate an action based on identifying the suspicious activity.

According to yet another embodiment, a method for tracking use of a physical token within a gaming venue can comprise maintaining, by a gaming system of the gaming venue, an electronic record storing a value. The value stored in the record can indicate a balance of a credit meter for a player of the gaming system. The gaming system can receive a request to transfer an amount from the credit meter to a physical token and validate the request to transfer the amount from the credit meter to the physical token. In response to validating the request to transfer the amount from the credit meter to the physical token, the gaming system can update the electronic record to decrement the balance of the credit meter by the amount, print the physical token with an indication of the amount, and send, to a ticketing system of the gaming venue, an electronic message identifying the physical token.

The ticketing system can receive, from the gaming system, the electronic message identifying the physical token, track activity within the gaming venue related to the physical token, and detect, based on the tracking of the activity within the gaming venue related to the physical token, an attempt to redeem the physical token. The ticketing system can then determine whether to permit redemption of the physical token, e.g., based on an amount of time since the physical token was printed, based on a location within the gaming venue of the detected attempt to redeem the physical token, etc. Additionally, or alternatively, the ticketing system can determine, based on the tracking of the activity within the gaming venue related to the physical token, whether the activity matches an activity predefined as being suspicious.

Additional features and advantages are described herein and will be apparent from the following Description and the figures.

### BRIEF DESCRIPTION OF THE SEVERAL VIEWS OF THE DRAWINGS

FIG. 1 is a diagram illustrating a gaming venue environment in which embodiments of the present disclosure may be implemented.

FIG. 2 is a block diagram illustrating additional details and components of a gaming system according to one embodiment of the present disclosure.

FIG. 3 is a block diagram illustrating additional details and components of a ticketing system according to one embodiment of the present disclosure.

FIG. 4 is a flowchart illustrating an exemplary process for generating a physical token in a gaming venue according to one embodiment of the present disclosure.

FIG. 5 is a flowchart illustrating an exemplary process for generating a physical token in a gaming venue according to another embodiment of the present disclosure.

FIG. 6 is a flowchart illustrating an exemplary process for generating a physical token in a gaming venue according to yet another embodiment of the present disclosure.

FIG. 7 is a flowchart illustrating an exemplary process for tracking use of a physical token in a gaming venue according to one embodiment of the present disclosure.

### DETAILED DESCRIPTION

Embodiments of the present disclosure will be described in connection with methods and systems for electronically transferring value between individuals in a cashless gaming venue solution. According to one embodiment, a player in a gaming venue can interact with a service window user interface presented by a gaming system or their mobile device to trigger the gaming system to generate, e.g., print a physical token comprising a cash-out ticket equal to an amount they desire to tip a casino staff member. This allows the player to pay out any appropriate amount to the casino staff member, and also benefits, in certain scenarios and embodiments, from the fact that tickets are anonymous instruments, which makes it difficult for a casino to track the amount of tips given to its staff members. This lack of tracking may be useful to avoid disputes with other staff members, or the casino itself over tip sharing. With that said, there are other embodiments where tracking of tips printed to tickets may be useful, such as for Anti-Money Laundering (AML) purposes and catching potential collusion between employees and cheaters.

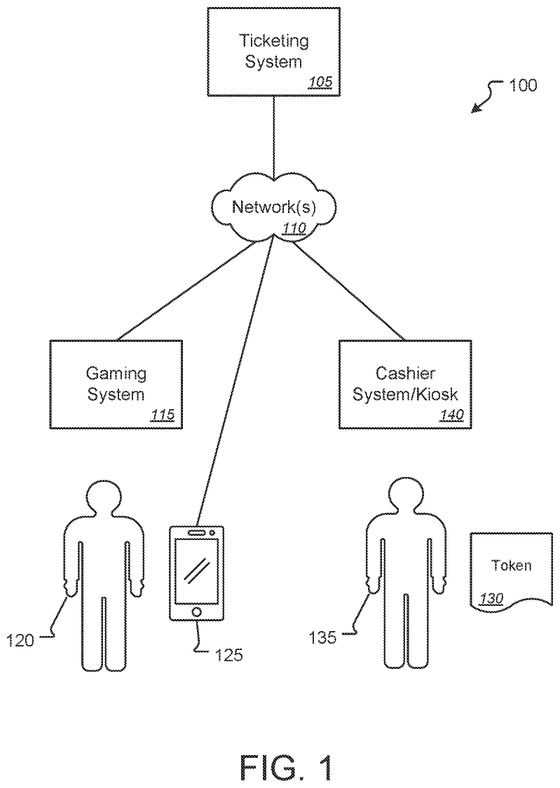

FIG. 1 is a diagram illustrating a gaming venue environment in which embodiments of the present disclosure may be implemented. As illustrated in this example, a gaming venue environment 100 can include a ticketing system 105 such as may be implemented on any one or more servers or other computing devices. The ticketing system 105 can be communicatively coupled with one or more communication network(s) 110. The communication network(s) 110 can comprise any one or more wired and/or wireless local area and/or wide area networks as known in the art. Also coupled with the communication network(s) 110 can be any number of gaming systems 115 including, but not limited to, an Electronic Gaming Machine (EGM), a video poker machine, a video lottery terminal, a terminal associated with an electronic table game, a video keno machine, a video bingo machine located on a casino floor, a sports betting terminal, or a kiosk, such as a sports betting kiosk, etc. One or more cashier systems or kiosks 140 can also be coupled with the communication network(s) 110.

According to one embodiment, a user interface can be presented by the gaming system 115 which allows a player 120 to select an amount to tip an attendant or other staff 135. For example, upon selection of the amount, the player 120 may press “accept”, may optionally confirm the amount in a secondary confirmation screen, and upon confirmation, the gaming system 115 can coordinate with the ticketing system 105 print a physical token 130, such as a paper ticket, indicating and redeemable for the selected amount. The player 120 can then hand this physical token 130 over to the casino staff member 130 that they'd like to tip.

Please note that typical gaming system 115 to host communications protocols may not allow a host, such as the ticketing system 105, the ability to remotely transfer amounts from the credit meter to a ticket or other physical token 130. As a result, the ticketing system 105 may have to first transfer funds off the gaming system's 115 credit meter, and then transfer those funds back to the gaming system 115, and in the transfer back to the gaming system 115, inform the gaming system 115 to pay them to the player via the printing of a physical token 130, rather than depositing them on the gaming system's 115 credit meter. This transfer to the ticketing system 105 may upset an accounting audit, which audits the gaming system's 115 cashless transfer meters against transfer transactions recorded by the resident cashless system. As a result, the ticketing system 105 involved in the tip transaction may have to inform the cashless system (not shown here) or accounting system (not shown here) of the tip to ticket transfer such that the metered vs. actual audit of the accounting system won't display a variance.

According to one embodiment, the gaming system 115 may prevent the player 120 from selecting an amount greater than the amount on the player's credit meter. This helps the player avoid attempting to print a physical token 130 for a tip that will result in a failure, as the gaming system 115 does not have the requested amount on the credit meter.

In another embodiment, the player 120 may be able to choose a tip amount greater than what's on the credit meter. This may be useful in scenarios where the player's 120 jackpot was paid to their cashless account, rather than to the gaming system's 115 credit meter. In this embodiment, the ticketing system 105, or a component of the back-end of the gaming venue's management system (not shown here) may notice that the requested amount is over the gaming system's 115 credit meter limit, and coordinate a transfer of a least the amount required to fully fund the requested amount, to the gaming system 115. Once the transfer to the gaming system 115 from the cashless system has completed, then the ticketing system 105, or a component of the back-end system, may then coordinate with the gaming system's 115 to print a physical token 130 of the requested tip amount. Once the physical token 130 of the requested amount is printed, the player 120 can hand the physical token 130 to the casino staff member 135 that they wish to tip.

In one embodiment, the tipping feature may be enabled at all times. Alternatively, it could only be enabled at certain, specific times, such as after a jackpot has been processed. In one embodiment, the tipping feature and associated user interface of the gaming system 115 or mobile application running on the player's 120 mobile device 125 may become focused, or notify the player 120 in some manner, to remind them to think about tipping their casino staff member 135 after a jackpot has been successfully processed.

In some embodiments, the player 120 may be prohibited from performing any other monetary transaction until an outstanding marker amount is paid off. In environments with this type of constraint, the tipping feature of the gaming system 115 and ticketing system 105 may not be made available to the player if they have an outstanding marker amount. For example, the gaming system 115 may be prevented from presenting the tipping user interface or the mobile device 125 of the player 120 may be prevented from presenting a tipping function therein. In another embodiment, the player 120 may be able to issue a tip through a physical token 130, but the amount may be constrained where the player 120 may only be able to select an amount to tip that ensures that funds still remain to pay back their outstanding marker amount. For example, if the player has $500 on the credit meter, and an outstanding marker amount of $400, the gaming system 115 and/or ticketing system 105 may limit the player 120 to issuing a physical token 130 for a tip anywhere between $0 and $100. In another embodiment, the gaming system 115 and/or ticketing system 105 may force the player 120 to first pay back their outstanding marker amount in some fashion before generating a physical token 130. For example, the player 120 may be reminded that they must pay back their outstanding marker amount before the “tip to ticket” feature is enabled, or the player 120 may be presented with a user interface that helps them pay back their outstanding marker. In another example, the player 120 may be constrained to select an amount up to the current credit meter amount, or credit meter plus his cashless account balance, minus the outstanding marker amount owed, and then the gaming system 115 and/or ticketing system 105 may perform both transactions at the same time, i.e., paying back the marker amount and printing a tip ticket.

According to one embodiment, the gaming system 115 and/or ticketing system 105 may require the player 120 to enter a Personal Identification Number (PIN) before giving them access to the user interface that lets them select an amount to tip a casino staff member 135. In another embodiment, the gaming system 115 and/or ticketing system 105 may require the player 120 to enter the PIN of their casino player tracking account, e.g., a loyalty or similar account, as part of the tipping confirmation user interface. In another embodiment, the player 120 may not have to enter a PIN if they've entered a PIN already during a session. In another embodiment, the player 120 may be sent a notification to their mobile device 125 by the gaming system 115 and/or ticketing system 105 to approve the printing of the physical token 130 for the tip amount. In another embodiment, the player 120 may be sent a Short Message Service (SMS) or text message to the mobile phone number associated with their account and they may be asked to approve by replying with a “yes” or other equivalent response. In another embodiment, player 120 may be sent via SMS, text, or a mobile notification a random code (ex: 4 digit code) that they must enter into the user interface of the gaming system 115 to confirm their acceptance of the amount to print a tipping ticket.

One potential concern is that a player 120 could be leveraging this technology to pass winnings to third parties via an anonymous instrument, i.e., the physical token 130 in turn raising concerns about cheating, money laundering, etc. In order to address these concerns, embodiments can restrict the tipping feature to only function for known players, i.e., players that are identified by connecting with the gaming system 115 via their known or registered mobile device 125 or otherwise “carding into” the gaming system 115, so that information associated with tips generated by each known player can be tracked for reporting purposes, and limits can also potentially be imposed. For example, the ticketing system 105 and/or other components of the back-end system may be informed when a player 120 prints a physical token 130 for tipping. The ticketing system 105 and/or other back-end system may provide reports on a per player basis. The ticketing system 105 and/or other back-end system could also automatically flag certain suspicious series of physical tokens 130 printed and generate warnings or alerts for the gaming venue operator to investigate. For example, the ticketing system 105 and/or other back-end system could email one or more staff members when concerning patterns have been detected. In another embodiment, the ticketing system 105 and/or other back-end system could generate a Suspicious Activity Report (SAR) or Currency Transaction Report (CTR) that may have to be filed with the US Government's FinCEN agency, either automatically by the ticketing system 105 and/or other back-end system, or manually by gaming venue employees after review.

As mentioned earlier, the ticketing system 105 and/or other back-end system could also implement limits on a per player basis in order to support financial transaction rules in a particular jurisdiction. For example, a player 120 may be limited to printing less than $2000 in physical tokens 130 per day in the United States in order to stay under FinCEN anti-money laundering rules.

In another embodiment, the issuing gaming system 115 may identify the physical token 130 printed for a casino staff member 135 tip in some fashion. For example, when the issued physical token 130 is reported to the ticketing system 105, it may be flagged or otherwise described as a tip ticket. In one embodiment, this can be done by setting a flag or enumeration value in a message used to report the physical token 130 issuance to the ticketing system 105. In another embodiment, an existing flag, field, or subset an existing field may be leveraged to convey this information to the ticketing system 105. For example, the system identifier of the physical token 130 validation number, which can be the two leading digits of a 16-digit physical token 130 validation number, can be set to 00 if the gaming system 115 is using “SAS Secure Enhanced” ticketing. In this embodiment, the gaming system 115 could set the two leading digits to another well-known value, such as “11”.

Once the ticketing system 105 has recorded or flagged “tip to ticket” physical token 130 in a specific manner, then it can apply custom logic to those physical token 130 when attempts are made to redeem them. In one embodiment, the ticketing system 105 could only allow redemption of “tip to ticket” physical token 130 at a cashier's cage, and not allow redemption of “tip to ticket” physical token 130 at gaming systems 115. In another embodiment, the ticketing system 105 can apply a custom expiration period to “tip to ticket” physical tokens 130 that's different from the expiration period used for other physical tokens 130. For example, the ticketing system 105 could expire “tip to ticket” physical tokens 130 at the end of a current shift, or within 24 hours, etc. In another embodiment, any restriction on where “tip to ticket” physical tokens 130 can be redeemed could be used by the gaming venue to record any further information about the physical token 130, such as which employee redeemed the physical token 130. For example, a cashier cage attendant could be required to enter the casino employee's ID so that physical token 130 could be tracked for tax purposes in a given jurisdiction. This could also be used to track excessive redemptions by the same employee over time, which may indicate that a player has figured out how to cheat a gaming system 115 and they are engaged in collusion with an employee who may be in on the scam. For example, some gaming venues have deployed certain games with known bugs that high rollers take advantage of, and in some cases, employees have been paid off by the scammer/cheater to identify such games.

The gaming system 115 could additionally, or alternatively, inform the ticketing system 105 of the identity of the casino staff member associated with the physical token 130. For example, the gaming system 115 may require the employee who is being tipped to insert their employee card, or tap their phone to identify themselves. In another embodiment, the gaming system 115 may remember the employee ID associated with a recent transaction at the gaming system 115, such as the recent or current hand-pay transaction, and send this employee ID to the ticketing system 105 in addition, or as an alternative, to explicitly identifying the physical token 130 as a tip ticket.

Additionally, or alternatively, the physical token 130 can also be used in other, non-tip embodiments. For example, the physical token 130 could be used to pay for something non-gaming that the player 120 would like to purchase from an attendant or wait staff member at the gaming system 115, such as to pay for a drink. In the drink purchase embodiment, the player 120 could print a physical token 130 representing a $5 ticket drawn from the gaming system's 115 credit meter to pay for their drink delivered by a member of the wait staff at the gaming system 115. In this case, the physical token 130 can be treated differently from a traditional cash-out voucher since the casino wait staff member may not be able to redeem the ticket at the gaming system 115. The gaming system 115 can address this by identifying the physical token 130 as a purchase ticket using the same methods discussed earlier, i.e., using a custom validation ID prefix, sending an additional flag, etc., and the purchase can optionally be associated with the employee who the player 120 is giving the ticket to. This association with the employee may be useful for performing a later audit of the payment pouch that attendant or wait staff member carried around with them on their shift.

In another embodiment, the physical token 130 representing a purchase voucher could be treated as a bearer instrument redeemable for a good. For example, the player 120 could use a user interface of the gaming system 115 to purchase tickets to a concert later that evening, use value from the credit meter of the gaming system 115, and the gaming system 115 could print a physical token 130 representing the amount paid for the concert ticket or set of concert tickets, and that ticket could be redeemable later for the actual concert tickets or for entrance to the concert. As mentioned earlier, the gaming system 115 may identify the purchase tickets to the ticketing system 105 so that it can't be redeemed at another gaming system 115.

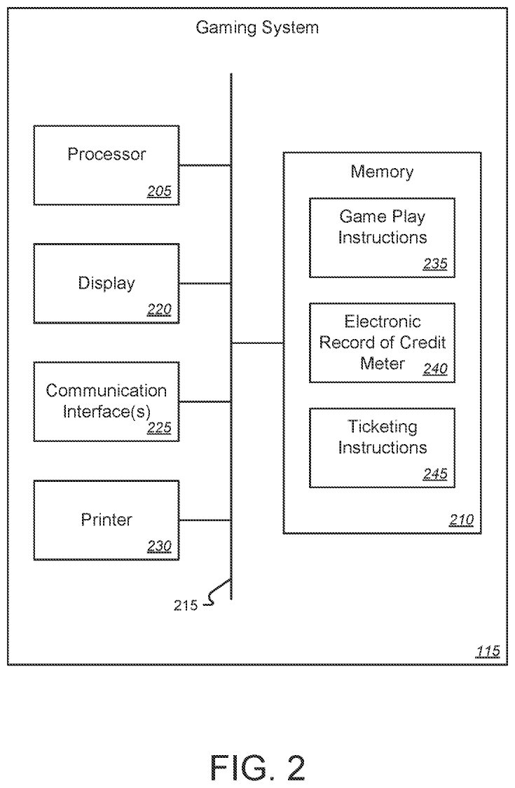

FIG. 2 is a block diagram illustrating additional details and components of a gaming system according to one embodiment of the present disclosure. As illustrated in this example, the gaming system 115 can comprise a processor 205. The processor 205 may correspond to one or many computer processing devices. For instance, the processor 205 may be provided as silicon, as a Field Programmable Gate Array (FPGA), an Application-Specific Integrated Circuit (ASIC), any other type of Integrated Circuit (IC) chip, a collection of IC chips, or the like. As a more specific example, the processor 205 may be provided as a microprocessor, Central Processing Unit (CPU), or plurality of microprocessors that are configured to execute the instructions sets stored in a memory 210. Upon executing the instruction sets stored in memory 210, the processor 205 enables various functions of the gaming system 115 as described herein.

The memory 210 can be coupled with and readable by the processor 205 via a communications bus 215. The memory 210 may include any type of computer memory device or collection of computer memory devices. Non-limiting examples of memory 210 include Random Access Memory (RAM), Read Only Memory (ROM), flash memory, Electronically-Erasable Programmable ROM (EEPROM), Dynamic RAM (DRAM), etc. The memory 210 may be configured to store the instruction sets depicted in addition to temporarily storing data for the processor 205 to execute various types of routines or functions.

The processor 205 can also be coupled with a display device 220, one or more communication interfaces 225, and a printer 230 via the communications bus 215. The display device 220 can comprise, for example, a Liquid Crystal Display (LCD), Light Emitting Diode (LED), Organic Light Emitting Diode (OLED), display or other type of display for presenting images and other graphics and can be touch sensitive allowing the user to use the display 320 as an input device as well. The communication interfaces 225 can comprise, for example, Ethernet, Bluetooth, WiFi, or other type of wired or wireless communications interfaces. The printer 230 can comprise any of a variety of printing devices including, but not limited to a dot matrix printer, ink jet printer, thermal printer, etc. which can output onto paper or other physical medium a physical token, such as a ticket, including indications of a value and other identifying information as described herein.

The memory 210 can store therein sets of instructions which, when executed by the processor 205, cause the processor 205 to operate the gaming system 115 as described herein. More specifically, the memory 210 can store therein a set of game play instructions 235 which, when executed by the processor 205, can cause the processor 205 to execute an electronic game such as any of a variety of games typically found in a gaming venue such as a casino and which can include, but are not limited to, slots, video poker, video lottery, an electronic table game, video keno, video bingo, etc. During execution of any such electronic game, the game play instructions 235 can cause the processor 205 to maintain in the memory 210 a credit meter 240. The credit meter 240 can comprise an electronic record 240 storing a value, e.g., accumulated winnings during game play of an electronic game executing on the gaming system, and which can indicate a balance or credit for a player of the gaming system 115.

The memory 210 can also have stored therein a set of ticketing instructions 245. The ticketing instructions 245, when executed by the processor 205, can cause the processor 205 to make a determination as to whether ticketing is enabled for the gaming system 115. For example, ticketing may be enabled at all times, certain times of day, after game play by the player for a certain, predetermined amount of time, based on events occurring in the electronic game, such as after a jackpot has been processed, etc.

In response to determining that ticketing is enabled, the ticketing instructions 245 can cause the processor 205 to present a user interface on the display device 220 of the gaming system 115. The user interface can provide the player 120 of the game the option to tip to ticket, i.e., generate a physical token 130 representing a redeemable value which can be provided, for example, to a staff member of the gaming venue. The ticketing instructions 245 can further cause the processor 205, based on the player's 120 interactions with this user interface, to receive a request to transfer an amount from the credit meter to the physical token 130. Additionally, or alternatively, the ticketing instructions 245 can cause the processor 205 to receive a request to transfer an amount from the credit meter to a physical token 130 from a mobile device 125 of the player 120 of the gaming system 115, e.g., through the communication interfaces 225 when the mobile device 125 of the player 120 when the mobile device 125 is paired or connected with the gaming system 115.

Regardless of whether the request is received through a user interface or from a mobile device 125, the ticketing instructions 245 can cause the processor 205 to validate the request to transfer the amount from the credit meter to the physical token 130. For example, validating the request to transfer the amount from the credit meter to the physical token 130 can comprise determining the balance of the credit meter indicated by the electronic record 240 exceeds the amount to be transferred to the physical token 130. Validating the request to transfer the amount from the credit meter to the physical token 130 can additionally, or alternatively, comprise requesting, via the user interface, identification information from the player 120 of the gaming system 115, e.g., a name, gaming venue loyalty program or other identification number, etc., and/or confirmation of the request from the player of the gaming system 115. Additionally, or alternatively, validating the request to transfer the amount from the credit meter to the physical token 130 can comprise requesting, from the mobile device 125 of the player 120, through the communication interfaces 225, identification information from the player of the gaming system, e.g., a name, gaming venue loyalty program or other identification number, etc., and/or confirmation of the request from the player 120 of the gaming system 115.

In response to determining the request to transfer the amount from the credit meter to the physical token 130 is validated, the ticketing instructions 245 can cause the processor 205 to update the electronic record 240 representing the credit meter to decrement the balance of the credit meter by the amount and generate the physical token 130, e.g., through the printer 230 of the gaming system 115. As noted, the token 130 can include an indication of the amount and available for redemption and may also include further identifying information as described above. The ticketing instructions 245 can further cause the processor 205 to send an electronic message identifying the physical token 130, e.g., by a number or code also indicated on the token 130, via the communication interfaces 225, to a ticketing system 105 of the gaming venue.

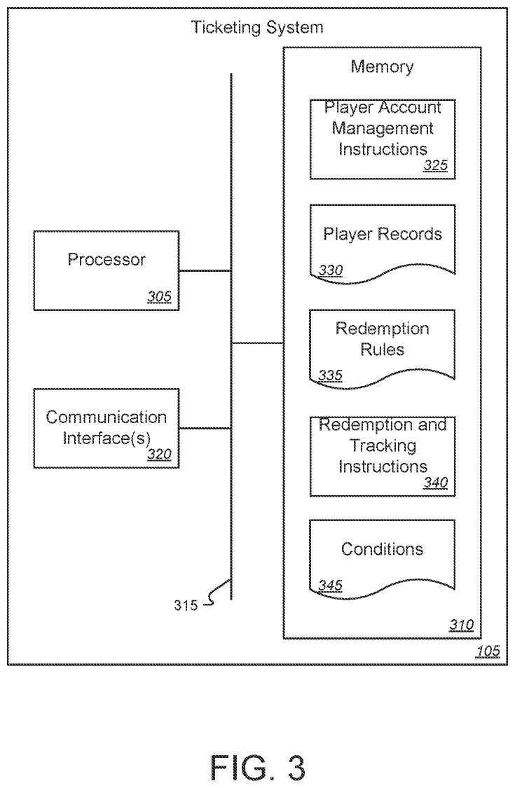

FIG. 3 is a block diagram illustrating additional details and components of a ticketing system according to one embodiment of the present disclosure. As illustrated in this example, the ticketing system 105 can comprise a processor 305 such as any of the various types of processors described above. A memory 310 can be coupled with and readable by the processor 305 via a communications bus 315. The memory 310 can comprises any one or more of the different types of volatile and/or non-volatile memories described above. The processor 305 can also be coupled with one or more communication interfaces 325 via the communications bus 315. The communication interfaces 320 can comprise, for example, a cellular, Bluetooth, WiFi, and/or other type of wireless communications interface.

The memory 310 can store therein sets of instructions which, when executed by the processor 305, cause the processor 305 to perform the functions of generating and/or tracking physical tokens 130 as described herein. More specifically, the memory 310 can store a set of player account management instructions 325 which, when executed by the processor 305, causes the processor to maintain or access electronic records 330 for players in the gaming venue. Each electronic record 330 can comprise a field storing a value indicating an account balance amount for a player 120, e.g., a pre-paid account, loyalty program points, etc.

The player account management instructions 330, when executed by the processor 305, can further cause the processor 305 to receive an electronic message indicating a request to transfer an amount from the account balance for the player 120 to a physical token 130. Such a request can be received through the communication interfaces 320 from a gaming system 115 of the gaming venue. Additionally, or alternatively, requests can be received through the communication interfaces 320 from a mobile device 125 of the player 120.

The player account management instructions 330 can further cause the processor 305 to validate the request to transfer the amount from the account balance for the player to the physical token 130. Validating the request to transfer the amount from the account balance for the player 120 to the physical token 130 can comprise determining the balance of the account indicated by the electronic record 330 exceeds the amount to be transferred to the physical token 130. Additionally, or alternatively, validating the request to transfer the amount from the account balance for the player 120 to the physical token 130 can comprise sending, to a mobile device 125 of the player 120, through the communication interfaces 320, an electronic message indicating the transfer and requesting an approval of the transfer. In such cases, validating the request to transfer the amount from the account balance for the player 120 to the physical token 130 can be based on receiving, from the mobile device 125 of the player 120, through the communication interfaces 320, an electronic message approving the transfer. The electronic message sent to the mobile device 125 of the player 120 can, in some cases, further request identifying information for the player 120, e.g., a name, Personal Identification Number (PIN), or other identification number, a password, etc. and validating the request to transfer the amount from the account balance for the player to the physical token 130 can comprise receiving an electronic message including the requested identifying information from the mobile device 125 of the player 120.

The player account management instructions 325, when executed by the processor 305, can further cause the processor 305 to update the electronic record 330 for the player 120 to decrement the account balance amount by the amount in response to determining to validate the request to transfer the amount from the account balance for the player 120 to the physical token 130. The player account management instructions 325 can also send an electronic message to another system of the gaming venue, e.g., to a gaming system 115 or other ticket generating system. The electronic message can comprise an instruction to initiate printing of the physical token 130 by the gaming system 115 with an indication of the amount and other information as described herein.

The memory 310 can also have stored therein a set of redemption and tracking instructions 340. When executed by the processor 305, the redemption and tracking instructions 340 can cause the processor 305 to receive, from the gaming system 115, an electronic message identifying a physical token 130 that has been generated. Based on this identifying information, activity within the gaming venue related to the physical token 130 can be tracked. More specifically, the redemption and tracking instructions 340 can cause the processor 305 to detect an attempt to redeem the physical token 130 based on the tracking of the activity within the gaming venue related to the physical token 130. The redemption and tracking instructions 340 can cause the processor 305 to determine whether to permit redemption of the physical token 130. This determination can be based on a set of redemption rules 335 defining allowable conditions for redemption, e.g., based on an amount of time since the physical token 130 was printed, based on a location within the gaming venue of the detected attempt to redeem the physical token 130, etc. Additionally, or alternatively, the redemption and tracking instructions 340 can cause the processor 305 to determine, based on the tracking of the activity within the gaming venue related to the physical token 130, whether the activity matches an activity predefined as being suspicious, e.g., if the activity matches predefined conditions 345 representing patterns of activity indicative of fraud, cheating, money laundering, etc. In response to determining to permit redemption and determining that the activity within the gaming venue related to the physical token 130 does not match activity predefined as being suspicious, the redemption and tracking instructions 340 can cause the processor 305 to initiate redemption, e.g., through the player account maintenance instructions 325 updating the player records 330 and instructing the gaming system 115 or other system of the gaming venue to generate the physical token 130. In response to determining the activity within the gaming venue related to the physical token 130 does match an activity predefined as being suspicious, the redemption and tracking instructions 340 can cause the processor 305 to initiate an action directed to this attempted redemption such as generation of a Suspicious Activity Report (SAR), a Currency Transaction Report (CRT), or other report, application of limits on other activities by the player requesting generation of the ticket or an individual attempting to redeem the ticket, etc.

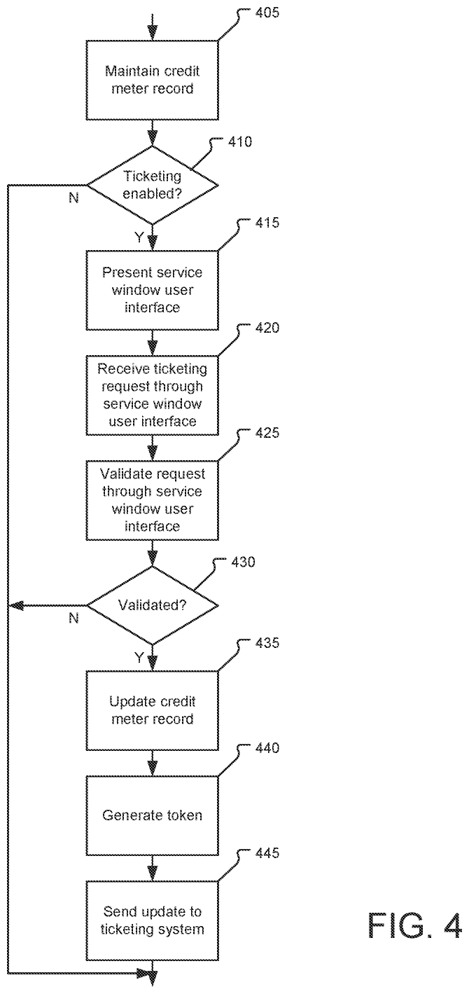

FIG. 4 is a flowchart illustrating an exemplary process for generating a physical token in a gaming venue according to one embodiment of the present disclosure. More specifically, this example illustrates a process by which a gaming system 115 may generate a physical token 130 using a user interface of the gaming system as described above. As illustrated in this example, the gaming system 115 can maintain 405 an electronic record storing a value, e.g., during game play of an electronic game executing on the gaming system. The value stored in the record can indicate a balance of a credit meter for a player of the gaming system. A determination 410 can be made as to whether ticketing is enabled for the gaming system 115. For example, ticketing may be enabled at all times, certain times of day, after game play by the player for a certain, predetermined amount of time, etc. Additionally, or alternatively, this determination 410 can be made based on events occurring in the electronic game executing on the gaming system 115, such as after a jackpot has been processed, etc.

In response to determining 410 that ticketing is enabled, a user interface can be presented 415 on the display device 220 of the gaming system 115. The user interface can provide the player 120 of the game the option to tip to ticket, i.e., generate a physical token 130 representing a redeemable value. Based on the player's 120 interactions with this user interface, a request to transfer an amount from the credit meter to the physical token 130 can be received 420 through the user interface.

The request to transfer the amount from the credit meter to the physical token 130 can then be validated 425. For example, validating 425 the request to transfer the amount from the credit meter to the physical token 130 can comprise determining the balance of the credit meter indicated by the electronic record 240 exceeds the amount to be transferred to the physical token 130. Additionally, or alternatively, validating 425 the request to transfer the amount from the credit meter to the physical token 130 can comprise requesting, via the user interface, identification information from the player 120 of the gaming system 115, e.g., a name, gaming venue loyalty program or other identification number, etc., and/or confirmation of the request from the player of the gaming system 115.

In response to determining 430 the request to transfer the amount from the credit meter to the physical token 130 is validated, the electronic record 240 can be updated 435 to decrement the balance of the credit meter by the amount and the physical token 130 can be generated 440, e.g., through the printer of the gaming system 115. As noted, the token 130 can include an indication of the amount and available for redemption. An electronic message identifying the physical token 130, e.g., by a number or code also indicated on the token 130, can be sent 445 to a ticketing system 105 of the gaming venue.

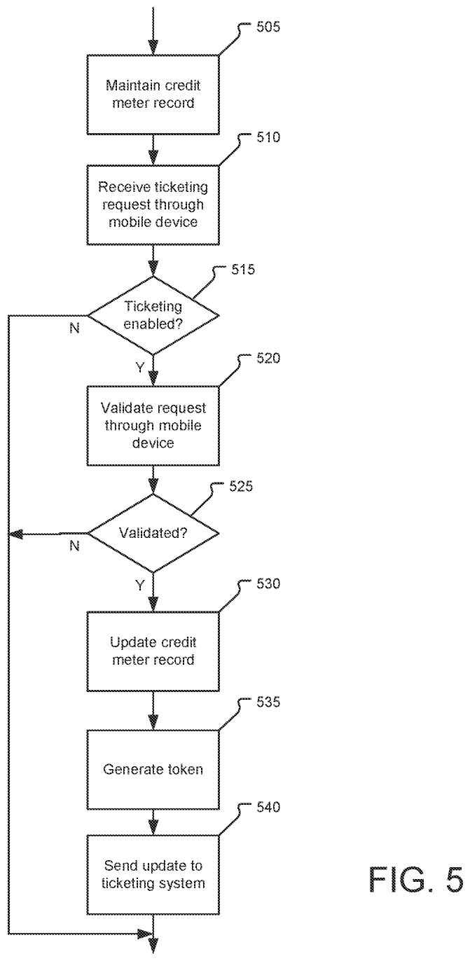

FIG. 5 is a flowchart illustrating an exemplary process for generating a physical token in a gaming venue according to another embodiment of the present disclosure. More specifically, this example illustrates a process by which a gaming system 115 may generate a physical token 130 based on a request from a mobile device as described above. As illustrated in this example, the gaming system 115 can maintain 505 an electronic record 240 storing a value, e.g., during game play of an electronic game executing on the gaming system 115. The value stored in the record can indicate a balance of a credit meter for a player 120 of the gaming system 115.

A request to transfer an amount from the credit meter to a physical token 130 can be received 510 from a mobile device 125 of the player 120 of the gaming system 115, e.g., through a wireless communication link between the gaming system 115 and the mobile device 125 of the player 120. A determination 515 can be made as to whether ticketing is enabled for the gaming system 115. For example, ticketing may be enabled at all times, certain times of day, after game play by the player 120 for a certain, predetermined amount of time, etc. Additionally, or alternatively, this determination 515 can be made based on events occurring in the electronic game executing on the gaming system 115, such as after a jackpot has been processed, etc.

In response to determining 515 that ticketing is enabled, the request to transfer the amount from the credit meter to the physical token 130 can be validated 520. For example, validating 520 the request to transfer the amount from the credit meter to the physical token 130 can comprise determining the balance of the credit meter indicated by the electronic record 240 exceeds the amount to be transferred to the physical token 130. Additionally, or alternatively, validating 520 the request to transfer the amount from the credit meter to the physical token 130 can comprise requesting, from the mobile device 125 of the player 120, identification information from the player of the gaming system, e.g., a name, gaming venue loyalty program or other identification number, etc., and/or confirmation of the request from the player 120 of the gaming system 115.

In response to determining 525 the request to transfer the amount from the credit meter to the physical token 130 is validated, the electronic record 240 can be updated 530 to decrement the balance of the credit meter by the amount and the physical token 130 can be generated 535, e.g., through the printer of the gaming system 115. As noted, the token 130 can include an indication of the amount and available for redemption. An electronic message identifying the physical token 130, e.g., by a number or code also indicated on the token 130, can be sent 540 to a ticketing system 105 of the gaming venue.

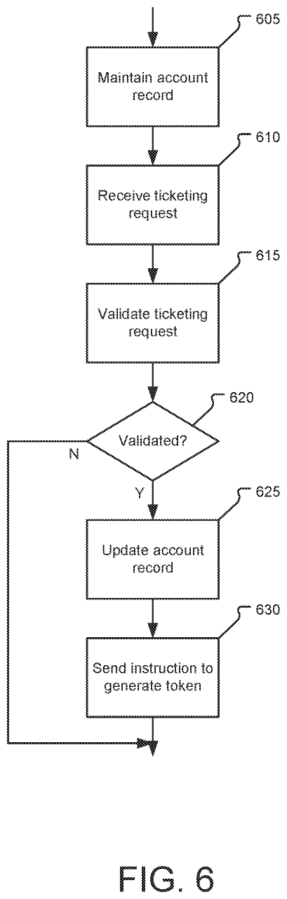

FIG. 6 is a flowchart illustrating an exemplary process for generating a physical token in a gaming venue according to yet another embodiment of the present disclosure. More specifically, this example illustrates a process by which a ticketing system 105 may imitate generation of a physical token 130 based on a request from a gaming system or a mobile device as described above. As illustrated in this example, the ticketing system 105 can maintain 605 or access an electronic record 330 for a player 120 of the gaming venue. The electronic record 330 can comprise a field storing a value indicating an account balance amount for the player 120, e.g., a pre-paid account loyalty program points, etc. An electronic message indicating a request to transfer an amount from the account balance for the player 120 to a physical token 130 can be received 610 from a gaming system of the gaming venue or from a mobile device 125 of the player 120.

The request to transfer the amount from the account balance for the player to the physical token 130 can then be validated 615. Validating 615 the request to transfer the amount from the account balance for the player 120 to the physical token 130 can comprise determining the balance of the account indicated by the electronic record 330 exceeds the amount to be transferred to the physical token 130. Additionally, or alternatively, validating 615 the request to transfer the amount from the account balance for the player 120 to the physical token 130 can comprise sending, to a mobile device 125 of the player 120, an electronic message indicating the transfer and requesting an approval of the transfer. In such cases, validating 615 the request to transfer the amount from the account balance for the player 120 to the physical token 130 can be based on receiving, from the mobile device 125 of the player 120, an electronic message approving the transfer. The electronic message sent to the mobile device 125 of the player 120 can, in some cases, further request identifying information for the player 120, e.g., a name, Personal Identification Number (PIN), or other identification number, a password, etc. and validating 615 the request to transfer the amount from the account balance for the player to the physical token 130 can comprise receiving an electronic message including the requested identifying information from the mobile device 125 of the player 120.

In response to determining 620 to validate the request to transfer the amount from the account balance for the player 120 to the physical token 130, the electronic record 330 can be updated 625 to decrement the account balance amount by the amount and an electronic message can be sent 630, e.g., to a gaming system 115. The electronic message can comprise an instruction to initiate printing of the physical token 130 by the gaming system with an indication of the amount.

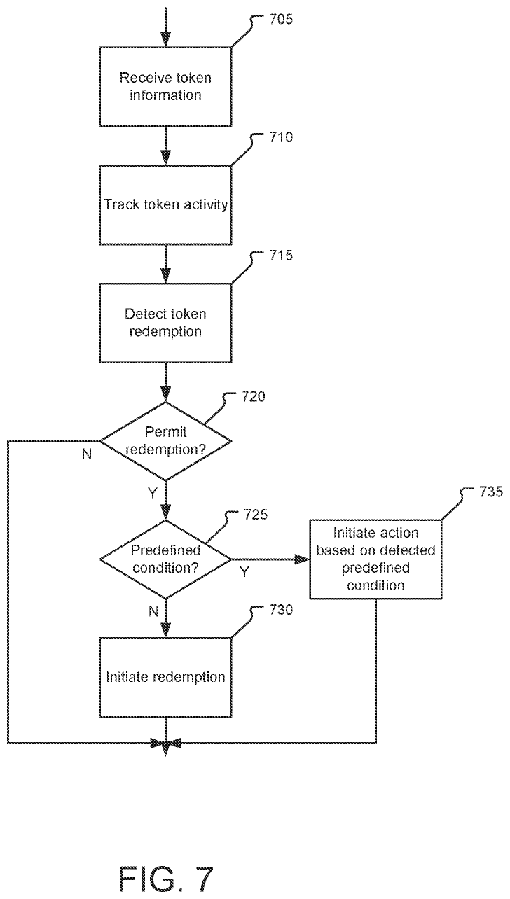

FIG. 7 is a flowchart illustrating an exemplary process for tracking use of a physical token in a gaming venue according to one embodiment of the present disclosure. As illustrated in this example, the ticketing system 105 can receive 705, from the gaming system 115, an electronic message identifying a physical token 130 that has been generated. Based on this identifying information, activity within the gaming venue related to the physical token 130 can be tracked 710. More specifically, based on the tracking 710 of the activity within the gaming venue related to the physical token 130, an attempt to redeem the physical token 130 can be detected 715. The ticketing system 105 can then determine 720 whether to permit redemption of the physical token 130. This determination can be based on a set of redemption rules defining allowable conditions for redemption, e.g., based on an amount of time since the physical token 130 was printed, based on a location within the gaming venue of the detected attempt to redeem the physical token 130, etc. Additionally, or alternatively, the ticketing system 105 can determine 725, based on the tracking 710 of the activity within the gaming venue related to the physical token 130, whether the activity matches an activity predefined as being suspicious, e.g., if the activity matches predefined patterns of activity indicative of fraud, cheating, money laundering, etc. In response to determining 720 to permit redemption and determining 725 that the activity within the gaming venue related to the physical token 130 does not match activity predefined as being suspicious, redemption can be initiated 730 or permitted to proceed. In response to determining 725 the activity within the gaming venue related to the physical token 130 does match an activity predefined as being suspicious, an action directed to this attempted redemption can be initiated 735 such as generation of a Suspicious Activity Report (SAR), a Currency Transaction Report (CRT), or other report, application of limits on other activities by the player requesting generation of the ticket or an individual attempting to redeem the ticket, etc.

A number of variations and modifications of the disclosure can be used. It would be possible to provide for some features of the disclosure without providing others.

The present disclosure contemplates a variety of different gaming systems each having one or more of a plurality of different features, attributes, or characteristics. A “gaming system” as used herein refers to various configurations of: (a) one or more central servers, central controllers, or remote hosts; (b) one or more electronic gaming machines such as those located on a casino floor; and/or (c) one or more personal gaming devices, such as desktop computers, laptop computers, tablet computers or computing devices, personal digital assistants, mobile phones, and other mobile computing devices. Moreover, an EGM as used herein refers to any suitable electronic gaming machine which enables a player to play a game (including but not limited to a game of chance, a game of skill, and/or a game of partial skill) to potentially win one or more awards, wherein the EGM comprises, but is not limited to: a slot machine, a video poker machine, a video lottery terminal, a terminal associated with an electronic table game, a video keno machine, a video bingo machine located on a casino floor, a sports betting terminal, or a kiosk, such as a sports betting kiosk.

In various embodiments, the gaming system of the present disclosure includes: (a) one or more electronic gaming machines in combination with one or more central servers, central controllers, or remote hosts; (b) one or more personal gaming devices in combination with one or more central servers, central controllers, or remote hosts; (c) one or more personal gaming devices in combination with one or more electronic gaming machines; (d) one or more personal gaming devices, one or more electronic gaming machines, and one or more central servers, central controllers, or remote hosts in combination with one another; (e) a single electronic gaming machine; (f) a plurality of electronic gaming machines in combination with one another; (g) a single personal gaming device; (h) a plurality of personal gaming devices in combination with one another; (i) a single central server, central controller, or remote host; and/or (j) a plurality of central servers, central controllers, or remote hosts in combination with one another.

For brevity and clarity and unless specifically stated otherwise, “EGM” as used herein represents one EGM or a plurality of EGMs, “personal gaming device” as used herein represents one personal gaming device or a plurality of personal gaming devices, and “central server, central controller, or remote host” as used herein represents one central server, central controller, or remote host or a plurality of central servers, central controllers, or remote hosts.

As noted above, in various embodiments, the gaming system includes an EGM (or personal gaming device) in combination with a central server, central controller, or remote host. In such embodiments, the EGM (or personal gaming device) is configured to communicate with the central server, central controller, or remote host through a data network or remote communication link. In certain such embodiments, the EGM (or personal gaming device) is configured to communicate with another EGM (or personal gaming device) through the same data network or remote communication link or through a different data network or remote communication link. For example, the gaming system includes a plurality of EGMs that are each configured to communicate with a central server, central controller, or remote host through a data network.

In certain embodiments in which the gaming system includes an EGM (or personal gaming device) in combination with a central server, central controller, or remote host, the central server, central controller, or remote host is any suitable computing device (such as a server) that includes at least one processor and at least one memory device or data storage device. As further described herein, the EGM (or personal gaming device) includes at least one EGM (or personal gaming device) processor configured to transmit and receive data or signals representing events, messages, commands, or any other suitable information between the EGM (or personal gaming device) and the central server, central controller, or remote host. The at least one processor of that EGM (or personal gaming device) is configured to execute the events, messages, or commands represented by such data or signals in conjunction with the operation of the EGM (or personal gaming device). Moreover, the at least one processor of the central server, central controller, or remote host is configured to transmit and receive data or signals representing events, messages, commands, or any other suitable information between the central server, central controller, or remote host and the EGM (or personal gaming device). The at least one processor of the central server, central controller, or remote host is configured to execute the events, messages, or commands represented by such data or signals in conjunction with the operation of the central server, central controller, or remote host. One, more than one, or each of the functions of the central server, central controller, or remote host may be performed by the at least one processor of the EGM (or personal gaming device). Further, one, more than one, or each of the functions of the at least one processor of the EGM (or personal gaming device) may be performed by the at least one processor of the central server, central controller, or remote host.

In certain such embodiments, computerized instructions for controlling any games (such as any primary or base games and/or any secondary or bonus games) displayed by the EGM (or personal gaming device) are executed by the central server, central controller, or remote host. In such “thin client” embodiments, the central server, central controller, or remote host remotely controls any games (or other suitable interfaces) displayed by the EGM (or personal gaming device), and the EGM (or personal gaming device) is utilized to display such games (or suitable interfaces) and to receive one or more inputs or commands. In other such embodiments, computerized instructions for controlling any games displayed by the EGM (or personal gaming device) are communicated from the central server, central controller, or remote host to the EGM (or personal gaming device) and are stored in at least one memory device of the EGM (or personal gaming device). In such “thick client” embodiments, the at least one processor of the EGM (or personal gaming device) executes the computerized instructions to control any games (or other suitable interfaces) displayed by the EGM (or personal gaming device).

In various embodiments in which the gaming system includes a plurality of EGMs (or personal gaming devices), one or more of the EGMs (or personal gaming devices) are thin client EGMs (or personal gaming devices) and one or more of the EGMs (or personal gaming devices) are thick client EGMs (or personal gaming devices). In other embodiments in which the gaming system includes one or more EGMs (or personal gaming devices), certain functions of one or more of the EGMs (or personal gaming devices) are implemented in a thin client environment, and certain other functions of one or more of the EGMs (or personal gaming devices) are implemented in a thick client environment. In one such embodiment in which the gaming system includes an EGM (or personal gaming device) and a central server, central controller, or remote host, computerized instructions for controlling any primary or base games displayed by the EGM (or personal gaming device) are communicated from the central server, central controller, or remote host to the EGM (or personal gaming device) in a thick client configuration, and computerized instructions for controlling any secondary or bonus games or other functions displayed by the EGM (or personal gaming device) are executed by the central server, central controller, or remote host in a thin client configuration.

In certain embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a local area network (LAN) in which the EGMs (or personal gaming devices) are located substantially proximate to one another and/or the central server, central controller, or remote host. In one example, the EGMs (or personal gaming devices) and the central server, central controller, or remote host are located in a gaming establishment or a portion of a gaming establishment.

In other embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a wide area network (WAN) in which one or more of the EGMs (or personal gaming devices) are not necessarily located substantially proximate to another one of the EGMs (or personal gaming devices) and/or the central server, central controller, or remote host. For example, one or more of the EGMs (or personal gaming devices) are located: (a) in an area of a gaming establishment different from an area of the gaming establishment in which the central server, central controller, or remote host is located; or (b) in a gaming establishment different from the gaming establishment in which the central server, central controller, or remote host is located. In another example, the central server, central controller, or remote host is not located within a gaming establishment in which the EGMs (or personal gaming devices) are located. In certain embodiments in which the communication network includes a WAN, the gaming system includes a central server, central controller, or remote host and an EGM (or personal gaming device) each located in a different gaming establishment in a same geographic area, such as a same city or a same state. Gaming systems in which the communication network includes a WAN are substantially identical to gaming systems in which the communication network includes a LAN, though the quantity of EGMs (or personal gaming devices) in such gaming systems may vary relative to one another.

In further embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include an internet (such as the Internet) or an intranet. In certain such embodiments, an Internet browser of the EGM (or personal gaming device) is usable to access an Internet game page from any location where an Internet connection is available. In one such embodiment, after the EGM (or personal gaming device) accesses the Internet game page, the central server, central controller, or remote host identifies a player before enabling that player to place any wagers on any plays of any wagering games. In one example, the central server, central controller, or remote host identifies the player by requiring a player account of the player to be logged into via an input of a unique player name and password combination assigned to the player. The central server, central controller, or remote host may, however, identify the player in any other suitable manner, such as by validating a player tracking identification number associated with the player; by reading a player tracking card or other smart card inserted into a card reader; by validating a unique player identification number associated with the player by the central server, central controller, or remote host; or by identifying the EGM (or personal gaming device), such as by identifying the MAC address or the IP address of the Internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the Internet browser of the EGM (or personal gaming device). Examples of implementations of Internet-based gaming are further described in U.S. Pat. No. 8,764,566, entitled “Internet Remote Game Server,” and U.S. Pat. No. 8,147,334, entitled “Universal Game Server.”

The central server, central controller, or remote host and the EGM (or personal gaming device) are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile Internet network), or any other suitable medium. The expansion in the quantity of computing devices and the quantity and speed of Internet connections in recent years increases opportunities for players to use a variety of EGMs (or personal gaming devices) to play games from an ever-increasing quantity of remote sites. Additionally, the enhanced bandwidth of digital wireless communications may render such technology suitable for some or all communications, particularly if such communications are encrypted. Higher data transmission speeds may be useful for enhancing the sophistication and response of the display and interaction with players.

As should be appreciated by one skilled in the art, aspects of the present disclosure have been illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure have been described herein with reference to flowchart illustrations and/or block diagrams of methods, apparatuses (systems) and computer program products according to embodiments of the disclosure. It should be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

What is claimed is:

1. A gaming system comprising:
a printer;
a processor coupled with the printer; and
a memory coupled with and readable by the processor and storing therein a set of instructions which, when executed by the processor, causes the processor to:
maintain an electronic record storing a value, the value indicating a balance of a credit meter for a player of the gaming system;
receive a request to transfer an amount from the credit meter to a physical token;
validate the request to transfer the amount from the credit meter to the physical token; and
in response to validating the request to transfer the amount from the credit meter to the physical token, update the electronic record to decrement the balance of the credit meter by the amount and generate, through the printer, the physical token with an indication of the amount.

2. The gaming system of claim 1, further comprising a display device coupled with the processor, wherein the instructions further cause the processor to present a user interface on the display device, and wherein the request to transfer the amount from the credit meter to the physical token is received through the user interface.

3. The gaming system of claim 2, wherein validating the request to transfer the amount from the credit meter to the physical token comprises requesting, via the user interface, identification information from the player of the gaming system and confirmation of the request from the player of the gaming system.

4. The gaming system of claim 1, further comprising a communications interface coupled with the processor and wherein the request to transfer the amount from the credit meter to the physical token is received from a mobile device of the player of the gaming system via the communications interface system.

5. The gaming system of claim 4, wherein validating the request to transfer the amount from the credit meter to the physical token comprises requesting, through the communications interface, from the mobile device of the player, identification information from the player of the gaming system and confirmation of the request from the player of the gaming system.

6. The gaming system of claim 1, wherein validating the request to transfer the amount from the credit meter to the physical token comprises determining the balance of the credit meter indicated by the electronic record exceeds the amount to be transferred to the physical token.

7. The gaming system of claim 1, wherein the instructions further cause the processor to disable transfers from the credit meter to the physical token under a set of predefined conditions.

8. A ticketing system of a gaming venue, the ticketing system comprising:
a communications interface;
a processor coupled with the communications interface; and
a memory coupled with and readable by the processor and storing therein a set of instructions which, when executed by the processor, causes the processor to:
maintain an electronic record for a player of the gaming venue, the electronic record comprising a field storing a value indicating an account balance amount for the player;
receive, from a gaming system of the gaming venue, through the communications interface, an electronic message indicating a request to transfer an amount from the account balance for the player to a physical token;
validate the request to transfer the amount from the account balance for the player to the physical token; and
in response to validating the request to transfer the amount from the account balance for the player to the physical token, update the electronic record to decrement the account balance amount by the amount and send, to the gaming system, through the communication interface, an electronic message comprising an instruction to initiate printing of the physical token with an indication of the amount by the gaming system.

9. The ticketing system of claim 8, wherein validating the request to transfer the amount from the account balance for the player to the physical token comprises sending, through the communications interface, to a mobile device of the player, an electronic message indicating the transfer and requesting an approval of the transfer.

10. The ticketing system of claim 9, wherein validating the request to transfer the amount from the account balance for the player to the physical token is based on receiving, through the communications interface, from the mobile device of the player, an electronic message approving the transfer.

11. The ticketing system of claim 10, wherein the electronic message sent to the mobile device of the player further requests identifying information for the player, and wherein validating the request to transfer the amount from the account balance for the player to the physical token comprises receiving an electronic message including the requested identifying information from the mobile device of the player.

12. The ticketing system of claim 8, wherein the instructions further cause the processor to maintain an electronic record of the request.

13. The ticketing system of claim 9, wherein the instructions further cause the processor to track activity related to the physical token.

14. The ticketing system of claim 9, wherein the instructions further cause the processor to identify, based on tracking the activity related to the physical token an activity predefined as a suspicious activity.

15. The ticketing system of claim 9, wherein the instructions further cause the processor to initiate an action based on identifying the suspicious activity.

16. A method for tracking use of a physical token within a gaming venue, the method comprising:
maintaining, by a gaming system of the gaming venue, an electronic record storing a value, the value indicating a balance of a credit meter for a player of the gaming system;
receiving, by the gaming system, a request to transfer an amount from the credit meter to a physical token;
validating, by the gaming system, the request to transfer the amount from the credit meter to the physical token; and
in response to validating the request to transfer the amount from the credit meter to the physical token, updating, by the gaming system, the electronic record to decrement the balance of the credit meter by the amount, printing, by the gaming system, the physical token with an indication of the amount, and sending, by the gaming system, to a ticketing system of the gaming venue, an electronic message identifying the physical token.

17. The method of claim 16, further comprising:
receiving, by the ticketing system, from the gaming system, the electronic message identifying the physical token;
tracking, by the ticketing system, activity within the gaming venue related to the physical token; and
detecting, by the ticketing system, based on the tracking of the activity within the gaming venue related to the physical token, an attempt to redeem the physical token.

18. The method of claim 17, further comprising determining, by the ticketing system, whether to permit redemption of the physical token based on an amount of time since the physical token was printed.

19. The method of claim 17, further comprising determining, by the ticketing system, whether to permit redemption of the physical token based on a location within the gaming venue of the detected attempt to redeem the physical token.

20. The method of claim 17, further comprising determining, by the ticketing system, based on the tracking of the activity within the gaming venue related to the physical token whether the activity matches an activity predefined as being suspicious.
